(19) United States
(12) Patent Application Publication
(10) Pub. No.: US 2008/0030543 A1
(43) Pub. Date: Feb. 7, 2008

(54) IMAGE FORMING APPARATUS HAVING ARRAY HEAD CARTRIDGE

(75) Inventors: Jung-dae HEO, Suwon-si (KR); Karp-sik Youn, Hwaseong-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/834,091

(22) Filed: Aug. 6, 2007

(30) Foreign Application Priority Data
Aug. 4, 2006 (KR) 2006-73794

(51) Int. Cl. B41J 2/145

(52) U.S. Cl. 347/40

(57) ABSTRACT

An image forming apparatus includes a feeding part which feeds a printing paper, an array head cartridge which has a plurality of head chips to jet ink onto the paper, and a paper supplying drum which transfers the paper fed from the feeding part to the array head cartridge, the head chips being provided in plural rows on a lower surface of the array head cartridge, the lower surface of the array head cartridge having a plurality of inclined surfaces toward the paper supplying drum, and the respective inclined surfaces being provided to have the same distances with respect to the paper supplying drum.

### CROSS-REFERENCE TO RELATED APPLICATIONS

This application claims priority from Korean Patent Application No. 10-2006-0073794, filed on Aug. 4, 2006, in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly, to an image forming apparatus having an array head cartridge.

2. Description of the Related Art

In general, an image forming apparatus includes an ink cartridge in which ink is stored and forms an image on a printing paper. The image forming apparatus is classified into a shuttle type and an array type according to an ink jetting method of the ink cartridge. In the shuttle type, one head chip having nozzles through which ink is jetted is provided in an ink cartridge, and the ink cartridge reciprocally moves in a distance corresponding to the width of the printing paper to jet ink on the paper. On the other hand, in the array type, a plurality of head chips corresponding to the width of the paper are provided in a row in the ink cartridge and the plurality of head chips jet ink at the same time.

Since the shuttle type image forming apparatus takes a moving time according to the movement of the ink cartridge, an image forming time in the shuttle type image forming apparatus gets longer than that in the array type image forming apparatus. Accordingly, recently the array type image forming apparatus has been under development so as to reduce the image forming time.

FIGS. 1A and 1B are a perspective view and a sectional view briefly illustrating a configuration of an array head cartridge 10 used for a conventional array type image forming apparatus. As illustrated in FIGS. 1A and 1B, the conventional array head cartridge 10 comprises an ink storing part 11 for storing ink and a plurality of head chips 13 provided on a lower surface 11a of the ink storing part 11. The ink storing part 11 has a length I₁ corresponding to a width of a printing paper. The head chips 13 are disposed on the lower surface 11a of the ink storing part 11 in plural rows X and Y so as to reduce the image forming time. The respective head chips 13 comprise nozzles through which ink is jetted, and the nozzles are provided to be corresponding to the four colors of yellow, magenta, cyan, and black.

FIG. 2 is an exemplary view briefly illustrating a process in which the conventional array head cartridge 10 jets ink onto a printing paper. The array head cartridge 10 jets the respective color ink on the paper transferred along a surface of a paper supplying drum 20 which rotates. At this time, the lower surface 11a of the conventional array cartridge 10 is horizontally provided as a horizontal flat surface. Since the paper supplying drum 20 has a curved-surface shape, a distance between the head chips 13 and the paper supplying drum 20 becomes farther as it moves from a center of the array head cartridge 10 to its edge part. Accordingly, there is a problem that the ink jetting distance jetted from the nozzles of the respective head chips 13 varies according to the respective colors (δ1≠δ2).

Accordingly, the conventional image forming apparatus has a problem that its image quality is depreciated due to the difference in concentration of ink jetted on the printing paper. So as to prevent the above-described problem, the conventional image forming apparatus separately controls an ink jetting speed and the concentration of the nozzles according to the head chips having respective colors, or has decreased a curvature of the paper supplying drum 20 so as to reduce the jetting distance variation of the respective color ink. However, there is a problem that an extra manufacturing cost is demanded so as to control the ink jetting speed of the nozzles having a minute size. Also, there is another problem that the entire size of the image forming apparatus becomes large since the diameter of the paper supplying drum 20 should be provided large in the case that the curvature of the paper supplying drum is decreased.

### SUMMARY OF THE INVENTION

The present general inventive concept provides an image forming apparatus having a shape of an array head cartridge to uniformly maintain a distance between a paper supplying drum and respective head chips.

Additional aspects and utilities of the present general inventive concept will be set forth in part in the description which follows and, in part, will be obvious from the description, or may be learned by practice of the general inventive concept.

The foregoing and/or the aspects of the present general inventive concept can be achieved by providing an image forming apparatus comprising: a feeding part which feeds a (printing) paper; an array head cartridge which has a plurality of head chips jetting ink onto the paper; and a paper supplying drum which transfers the paper fed from the feeding part to the array head cartridge, the head chips being provided in plural rows on a lower surface of the array head cartridge, and the lower surface of the array head cartridge having a plurality of inclined surfaces toward the paper supplying drum, the respective inclined surfaces being provided to have the same distances with respect to the paper supplying drum.

According to the embodiment of the present invention, on the respective inclined surfaces are disposed one row of head chips.

According to the embodiment of the present invention, on the respective inclined surfaces are disposed plural rows of head chips.

According to the embodiment of the present invention, the respective rows of head chips are alternately disposed so as not to be adjacent to the other rows of head chips.

According to the embodiment of the present invention, the inclined surfaces are provided to be inclined as much as a predetermined angle α satisfying the following formula with respect to the neighboring inclined surfaces,

α=2×[90°−{tan⁻¹(B/(R+A))}]

where B donates a distance from the center of a transverse sectional surface of the array head cartridge to the center of the head chips, R denotes a radius of the paper supplying drum, and A denotes a distance from the center of the transverse sectional surface of the array head cartridge to the paper supplying drum.

The foregoing and/or the aspects of the present invention can be achieved by providing an image forming apparatus comprising: a feeding part which feeds a (printing) paper; an array head cartridge which has a plurality of head chips jetting ink to the paper; and a paper supplying drum which transfers the paper fed from the feeding part to the array head cartridge, the head chips being provided on a lower surface of the array head cartridge, and the lower surface of the array head cartridge having a curved surface corresponding to a curvature of the paper supplying drum.

The foregoing and/or the aspects of the present invention can be achieved by providing an array head cartridge comprising: an ink storing part in which ink is stored; a plurality of head chips which are provided on a lower surface of the ink storing part and jet the ink of the ink storing part to a printing paper; comprising the head chips being disposed on the lower surface of the ink storing part in plural rows; and the lower surface of the ink storing part having plural inclined surfaces which are corresponded to the plural rows and inclined toward a predetermined lower surface.

The foregoing and/or the aspects of the present invention can also be achieved by providing an array head cartridge including an ink storing part to store ink, and having a non-linear surface, and a plurality of head chips formed on corresponding portions of the non-linear surface to eject the ink of the ink storing part.

The non-linear surface may not be a flat surface.

The non-linear surface may be a non-planar surface.

The non-linear surface may be a curved surface, and the corresponding portions may be different locations of the curved surface.

The corresponding portions of the non-linear surface may include surfaces which are not parallel to each other.

The corresponding portions of the non-linear surface may include surfaces which are inclined with respect to each other.

The non-linear surface may include first and second surfaces which are not linear, and the plurality of head chips may include a first row of the head chips and a second row of head chips which are respectively disposed on the first and second surfaces.

The plurality of head chips may be disposed in the non-linear surface in a zigzag pattern with respect to a center line of the plurality of the head chips.

The array head cartridge may further include a main body containing the ink storing part and formed with the non-linear surface having a plurality of different portions as the corresponding portions, wherein the plurality of the head chips are disposed on corresponding ones of the different portions.

The non-linear surface may include first and second different linear surfaces disposed opposite with respect to a center line, the plurality of head chips may include first and second rows of head chips disposed on the respective first and second different linear surfaces, and the center line and center lines of the first and second rows of head chips may form a trigonal prism shape.

The non-linear surface may include first and second different linear surfaces disposed opposite with respect to a surface center line, the plurality of head chips may include first and second rows of head chips disposed on the respective first and second different linear surfaces, and a distance between the surface center line and one of head chip center lines of the first and second rows of head chips may be longer than half a distance between the head chip center lines.

The foregoing and/or the aspects of the present invention can be achieved by providing an image forming apparatus including a paper supplying unit having a paper supplying drum to feed a printing paper, and an array head cartridge disposed to face the paper supplying drum, having an ink storing part to store ink, having a non-linear surface, and a plurality of head chips formed on corresponding portions of the non-linear surface to eject the ink of the ink storing part on the fed printing paper.

The non-linear surface may include first and second different surfaces disposed opposite with respect to a center line therebetween, the plurality of head chips may include first and second rows of head chips disposed on the respective first and second different linear surfaces, and a distance between the center line and a surface of the paper supplying drum in a radial direction may be longer than a distance between one of center lines of the first and second rows of head chips and the surface of the paper supplying drum in the radial direction.

The plurality of head chips may include chip surfaces disposed perpendicular to a radial direction of the paper supplying drum.

The non-linear surface may include first and second different surfaces disposed perpendicular to a radial direction of the paper supplying drum.

### BRIEF DESCRIPTION OF THE DRAWINGS

These and/or other aspects and utilities of the present general inventive concept will become apparent and more readily appreciated from the following description of the exemplary embodiments, taken in conjunction with the accompanying drawings, in which:

FIGS. 1A and 1B are a perspective view and a sectional view illustrating a configuration of a conventional array head cartridge.

FIG. 2 is an exemplary view illustrating an image forming process of the conventional array head cartridge of FIGS. 1A and 1B.

FIG. 3 is a schematic view illustrating a configuration of an image forming apparatus according to an embodiment of the present general inventive concept.

FIGS. 4A and 4B are a perspective view and a sectional view illustrating a configuration of an array head cartridge of the image forming apparatus of FIG. 3 according to an embodiment of the present general inventive concept.

FIGS. 5A and 5B are exemplary views illustrating a process of determining an angle of an inclined surface of the array head cartridge of FIG. 3.

FIGS. 6A and 6B are exemplary views illustrating a configuration of an array head cartridge according to another embodiment of the present general inventive concept.

FIG. 7 is an exemplary view illustrating a configuration of an array head cartridge according to still another embodiment of the present general inventive concept.

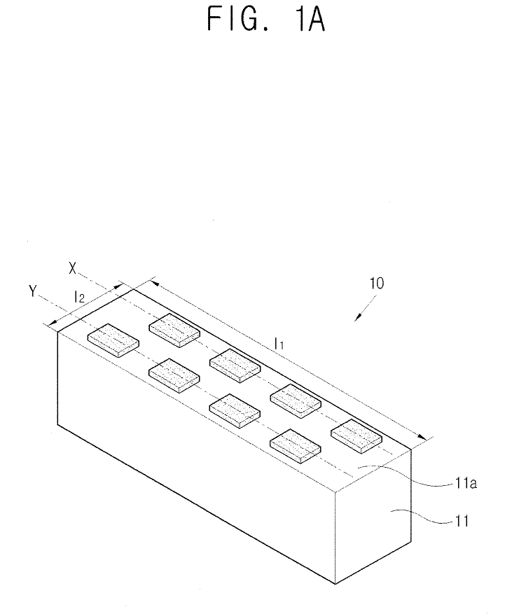

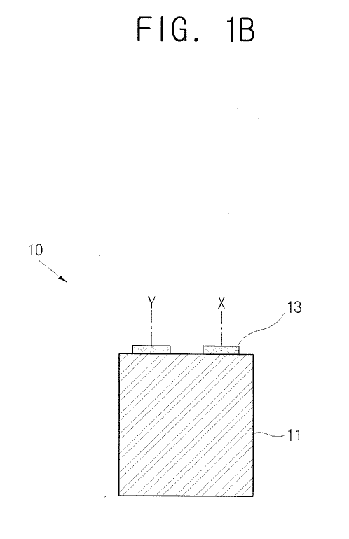

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below so as to explain the present general inventive concept by referring to the figures.

The same elements are given the same reference numerals in various embodiments, and they will be typically described in the first embodiment, and will be omitted in the other embodiments.

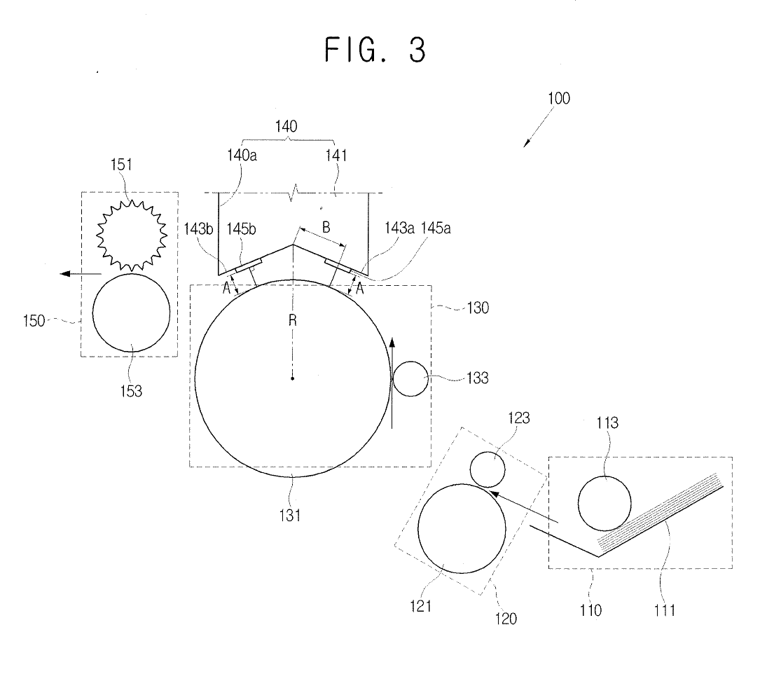

FIG. 3 is a schematic view briefly illustrating a configuration of an image forming apparatus 100 according to an embodiment of the present general inventive concept. As illustrated in FIG. 3, the image forming apparatus 100 according to the present embodiment comprises a feeding part 110 in which printing papers are stored, a transferring roller 120 to transfer a printing paper from the feeding part 110 to an array head cartridge 140 along a paper feeding path to print an image on the transferred printing paper, a paper supplying unit 130 to supply the printing paper transferred by the transferring roller 120 to the array head cartridge 140 while adsorbing the paper on its surface, and a discharging unit 150 to discharge the printing paper on which the image is formed by the ink jetted from the array head cartridge 140 to an outside thereof. In the array head cartridge 140, respective head chips (refer to 145a and 145b) are provided in a same distance A from the paper supplying unit 130, so that ink is ejected on the printing paper supplied by the paper supplying unit 130 or a same distance B from a center line of the array head cartridge 140, to form an image on the printing medium.

The feeding part 110 which stores plural numbers of papers on its upper surface transfers a printing paper to the paper supplying unit 120 if an output signal is applied thereto. The feeding part 110 comprises a paper storing plate 111 in which printing papers are stored, and a pick-up roller 113 which applies a friction force to the paper to feed the paper. The feeding part 110 may be provided outside of a main body (not shown) of the image forming apparatus 100 to project thereform, or may be integrally provided inside the main body. Also, the feeding part 110 may comprise an overlapping prevention member (not shown) to prevent the paper from being overlapped by applying a friction force to the paper.

The transferring roller 120 transfers the paper picked up from the feeding part 110 toward the array head cartridge 140. The transferring roller 120 comprises a pair of rollers 121 and 123 which face each other to rotate. One of the pair of rollers 121 and 123 may be provided as a driving roller 121 driven by a driving part (not shown), and the other one of the pair of rollers 121 and 123 may be provided as a driven roller rotated by driving of the driving roller 121. The transferring roller 120 may be provided in plural numbers according to the distance between the feeding part 110 and the array head cartridge 140 and the shape of a paper transferring path. The description of the configuration of the feeding roller 120 will be omitted as it is the same as a conventional configuration.

The paper supplying unit 130 transfers the paper having passed through the transferring roller 120 to the array head cartridge 140, and transfers the paper on which an image is formed in the array head cartridge 140 to the discharging unit 150. The paper supplying unit 130 comprises a paper supplying drum 131 which adsorbs the paper having passed through the transferring roller 120 on its surface to rotate, and a pressing roller 133 for maintaining an adsorbed state of the paper with respect to the paper supplying drum 131.

The paper supplying drum 131 adsorbs the paper having passed through the transferring roller 120 on its surface to supply the adsorbed paper to the array head cartridge 140. The paper supplying drum 131 is desirably provided as a cylindrical roller having a length corresponding to the width of the paper. A radius R of the paper supplying drum 131 may be provided to have a proper curvature so that the distance A from the paper adsorbed on its surface to the array head cartridge 140 can be within a predetermined range. Here, in the case that the radius R is smaller than the predetermined range, the relative curvature with respect to the array head cartridge 140 becomes large to depreciate an output quality. Also, in the case that the radius R is larger than the predetermined range, the entire size of the image forming apparatus 100 becomes larger. Accordingly, the paper supplying drum 131 is desirably designed to have a proper diameter.

The paper supplying drum 131 can adsorb the paper by supplying an electrostatic force to the paper or inhaling an outside air. In the case that the paper is adsorbed by an electrostatic force, the paper supplying drum 131 may comprise a power supplying part (not shown) which supplies power to the paper supplying unit 131 to electrify the surface of the paper supplying drum 131, a static electricity removing member (not shown) which removes the electrostatic force of the surface of the paper supplying drum 131 so as to separate the image-formed paper from the surface and transfer it to the discharging unit 150, and a grounding means (not shown) for grounding the paper.

Meanwhile, in the case that the paper is adsorbed on the surface by inhaling the outside air, the paper supplying drum 131 is provided with a plurality of inlets (not shown) on its surface for taking in the outside air, and a pump (not shown) inside the paper supplying drum 131 to inhale the air.

Here, the paper supplying drum 131 is desirably provided within a range which the transferring roller 121 and the electrostatic force, or an absorption force of the pump can reach. Accordingly, a leading edge of the paper having passed through the transferring roller 120 can be easily adsorbed on the surface of the paper supplying drum 131.

The pressing roller 133 presses the paper so that the leading edge of the paper having passed through the transferring roller 140 can be maintained in its adsorbed state with respect to the paper supplying drum 131. In general, the paper has a rectilinear property toward its original transferring direction in the case that its transferring path is changed during the transferring process. In particular, in the case that a curvature of the transferring path is changed, the paper has a property to proceed toward a tangential direction of its original curvature. Accordingly, in the case that the leading edge of the paper having passed through the transferring roller 121 is adsorbed on the surface of the paper supplying drum 131 by the electrostatic force or the absorption force of the paper supplying drum 131, the paper tends to be separated toward a tangential direction with respect to the curved shape of the paper supplying drum 131. The pressing roller 133 presses the paper so that the paper having the above property can be maintained in the state adsorbed on the surface of the paper supplying drum 131 and can be transferred to the array head cartridge 140.

The pressing roller 133 may be provided to have a proper pressure in consideration of the radius R of the paper supplying drum 131, an amount of the electrostatic force or the an amount of the absorption force of the paper supplying drum 131. Accordingly, the pressing roller 133 may be provided to have proper numbers of rollers.

The array head cartridge 140 according to the present embodiment comprises an ink storing part 141 which stores ink, a plurality of inclined surfaces 143a and 143b formed on the main body 140a to face a paper path of the paper and/or the paper supplying unit 130, and a plurality of head chips 145a and 145b which are provided on the plurality of inclined surfaces 143a and 143b to jet ink onto the printing paper. The main body 140a or the ink storing part 141 is provided to have a length corresponding to a width of the paper. The lower surface of the ink storing part 141 has the plurality of inclined surfaces 143a and 143b provided to have a same distance from the paper supplying drum 131. The head chips 145a and 145b are provided in a plurality of rows, and the head chips 145a and 145b in the respective rows are provided on the respective inclined surfaces 143a and 143b. Meanwhile, the array head cartridge 140 comprises an FPC (a flexible printed circuit) to supply power to the respective head chips 145a and 145b. The head chips 145a and 145b are respectively disposed on first and second rows arranged in a widthwise direction of the paper which is perpendicular to the printing path or a lengthwise direction of the paper. Centers of the head chips 145a and 145b in the widthwise direction are a same distance from a circumferential surface of the paper supplying drum 131 in a radial direction of the paper supplying drum 131.

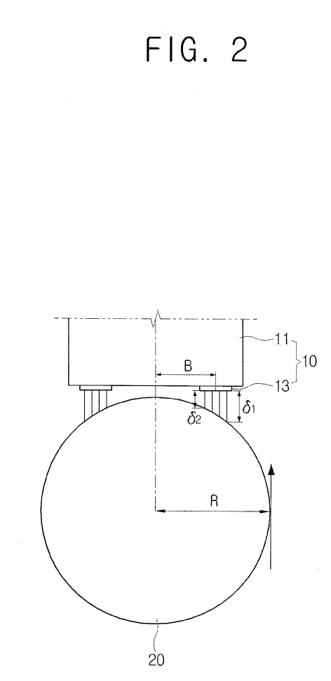

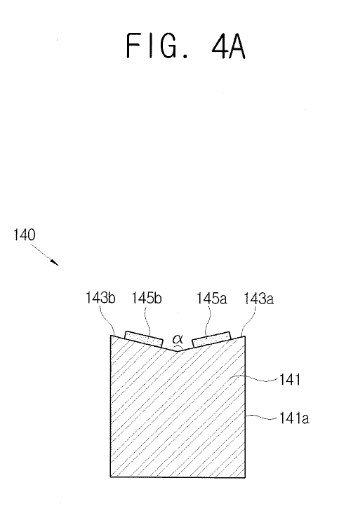

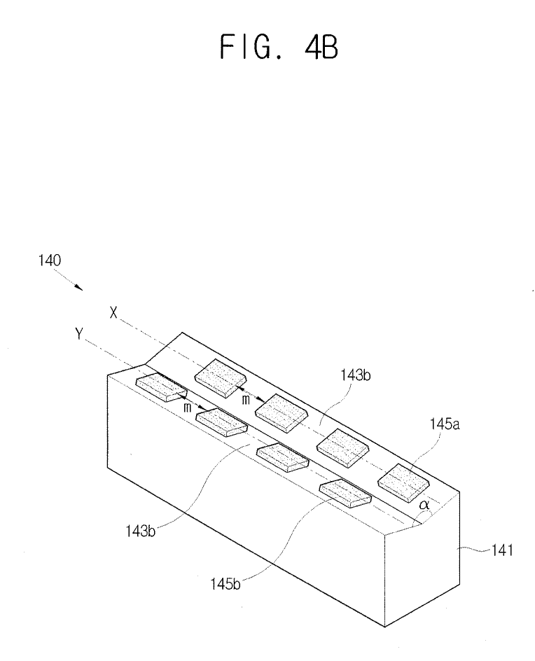

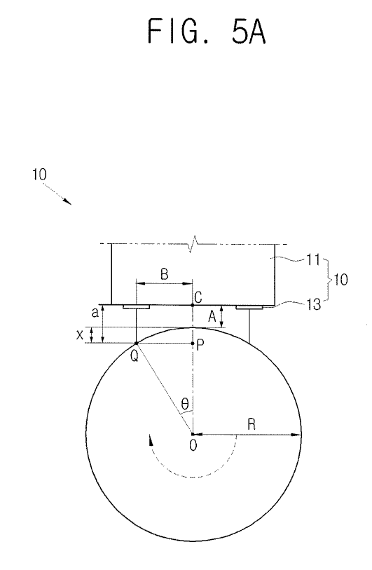

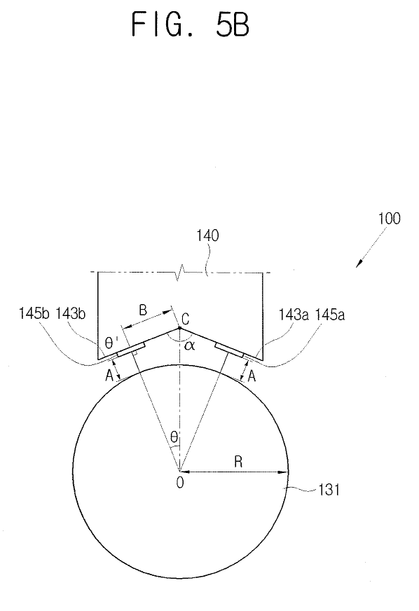

As illustrated in FIGS. 4A and 4B, the main body 140a having the ink storing part 141 according to an embodiment of the present general inventive concept has two inclined surfaces 143a and 143b provided to be inclined to form a predetermined angle α. Here, the predetermined angle α enables a distance ‘A’ from the center C of a transverse section of the ink storing part 11 to a surface of the paper supplying drum 20, that is, a distance ‘A’ from a center of a head chip and a surface of the paper supplying drum 20 in a vertical direction of the head chip, and a distance ‘a’ from the center of the head chip 13 disposed in the main body 140a or the ink storing part 11 to the paper supplying drum 20 to be the same in an array head cartridge 10 as illustrated in FIGS. 2 and 5A.

Here, the difference ‘x’ between the distance ‘A’ from the center C of the transverse section of the ink storing part 11 to the paper supplying drum 20 and the distance ‘a’ from the center of the head chip 13 to the paper supplying drum 20 can be calculated by the below numerical formula 1 by using a trigonometrical function of a triangle having O, P, and Q as three vertexes. Here, the difference ‘x’ between the distance ‘A’ from the center C of the transverse section of the ink storing part 11 to the ink supplying drum 20 and the distance ‘a’ from the center of the head chip 13 to the paper supplying drum 20 is corresponded to the difference between the ink jetting distance δ2 of the innermost center part and the ink jetting distance δ1 of the outermost part away from the center C of the transverse section in the nozzles (not shown) jetting respective color ink in the head chip 13 in FIG. 2 (x=(δ1−δ2).

x=R−R cos(sin⁻¹(B/R)) [formula 1]

The distance ‘a’ of the ink jetted from the center of the head chip 13 can be calculated by the difference ‘x’ made by the above-described formula 1. The jetting distance ‘a’, which is the sum of the distance ‘A’ from the center C of the transverse section of the ink storing part 11 to the ink supplying roller 20 and the distance ‘x’ which is the difference in length between the distance ‘A’ from the center C of the transverse section of the ink storing part 11 to the ink supplying drum 20 and the distance ‘a’ from the center of the head chip 13 to the paper supplying drum 20, can be calculated by the following formula 2.

a=R−R cos(sin⁻¹(B/R))+A [formula 2]

When it is assumed that the distance ‘A’ from the center of the head chip 143b to the paper supplying drum 131 in FIG. 5B is the same as the distance ‘A’ from the center of the ink storing part 11 to the ink supplying roller 20 in FIG. 5A, a proper ink jetting distance ‘A’ which is the distance from the center of the head chip 13 to the paper supplying drum 131 can be obtained by adjusting the angle α between two inclined surfaces 143a and 143b of the array head cartridge 140 according to the present embodiment using the following formula 3 with a trigonometrical function having three vertexes of O, C, and Q′.

α/2=[90°−{tan⁻¹(B/(R+A))}

α=2×[90°−{tan⁻¹(B/(R+A))}] [formula 3]

As illustrated in FIGS. 4A and 4B, in the array head cartridge 140 according to the present embodiment are inclined-provided the two inclined surfaces 143a and 143b having the angle α made by the above-described formulas, and on the two inclined surfaces 143a and 143b are respectively provided plural rows of the head chips 145a and 145b. Accordingly, the difference of the respective jetting distances of the ink jetted toward the paper supplying drum 131 from the respective color nozzles provided in the respective head chips 145a and 145b can be reduced.

The head chips 145a and 145b comprise a plurality of nozzles (not shown) for jetting ink stored in the ink storing part 141 onto a printing paper. The nozzles are provided to be corresponding to the four colors of yellow, magenta, cyan, and black. The respective rows of head chips 145a and 145b are disposed on the respective inclined surface 143a and 143b to have the same interval ‘m’. Also, it is desirable for preventing ink from unnecessarily being wasted so that the respective rows of head chips 145a and 145b are alternately disposed not to be adjacent to the neighboring rows of head chips 145a and 145b.

The respective rows of head chips 145a and 145b at the same time or sequentially jet ink onto a printing paper to form an image thereon. That is, in the case that the head chips 145a and 145b are disposed in plural rows, the rows of the head chips 145a and 145b are controlled to jet sequentially jet ink by sorted odd number rows and even number rows or may be controlled to form an image on the paper at the same time.

An intersection between the two inclined surfaces 143a and 143b is formed in an rotation axis direction of the paper supplying drum 131 and is spaced apart from the paper supplying drum 131 by a distance longer than the distance A between the center of the head chips 145a and 145b and a surface of the paper supplying unit 131 in a radial direction. The intersection may be formed a portion of the main body 140a between the two rows of the head chips 145a and 145b.

The main body 140a or the ink storing part 141 may have a side on which the head chips 145a and 145b are mounted to communicate with the ink storing part 141 to receive the ink and to eject the ink through the nozzles. The two inclined surfaces 143a and 143b may be formed on the side of the main body 140a which is not a flat plain surface but a non-linear surface or a non-planar surface. The non-linear surface or non-planar surface includes the inclined surfaces, for example. The head chips 145a and 145b are mounted on corresponding ones of surfaces of the non-linear surface or non-planar surface.

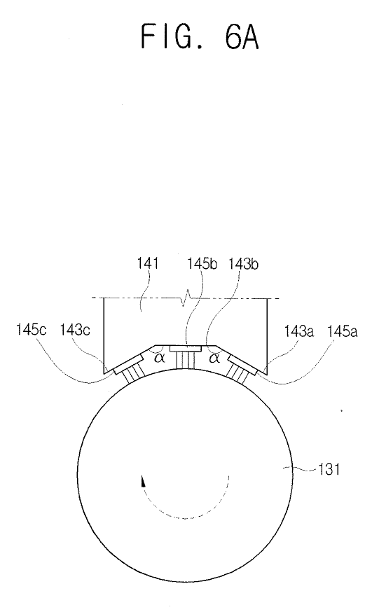

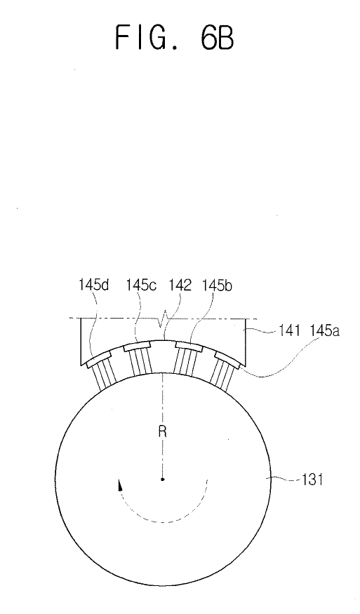

Meanwhile, as illustrated in FIGS. 4A and 4B, the array head cartridge 140 according to an embodiment of the present general inventive concept is provided to have two inclined surfaces 143a and 143b provided on the same distance as the paper supplying drum 131, but may be provided to have a plurality of inclined surfaces according to the number of the rows of the head chips 145a and 145b. Here, in the case that the rows of the head chips 145a and 145b have odd numbers, as shown in FIG. 6A, in a center part of the ink storing part 141 is disposed a row of head chips 145b, and in opposite end parts from the center part are provided a pair of inclined surfaces 143a and 143c for the rows of the head chips 145a and 145c to have the same ink jetting distance ‘A’ as the distance ‘A’ from the row of the head chips 145b to the paper supplying drum 131.

Also, as the number of rows of the head chips 145 increases, the number of the inclined surfaces 143 of the ink storing part 141 can be increased. As the number of the inclined surfaces increases, a variation of ink jetting route among the respective color ink jetted from the head chips (not shown) provided on the respective inclined surfaces can be decreased since the shape of the lower surface can be corresponding to the curvature of the paper supplying drum 131.

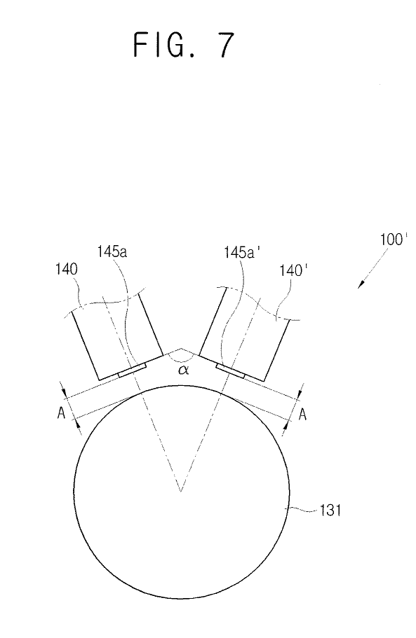

Also, as illustrated in FIG. 6B, the shape of the lower end part of the ink supplying part 141 may be provided as a curved surface to correspond with the curved shape of the paper supplying drum 131. In this case, the shapes of the respective head chips 145 are provided to have curved surfaces, or may be provided to correspond with the curved shape of the paper supplying drum 131 by differentiating the method in which the respective head chips 145 are adhered to the ink supplying part 141. In this case, since the ink jetting route variation among the ink jetted from the respective color nozzles can be removed, thereby obtaining an optimal image quality. As illustrated in FIGS. 3, 4A, 4B, 6A and 6B, one array head cartridge according to an exemplary embodiment of the present invention includes a plurality of inclined surfaces 143 or a curved surface corresponding to a curvature of the paper supplying unit 130, but not limited thereto. Alternatively, as illustrated in FIG. 7, an image forming apparatus 100′ may include a plurality of array head cartridges 140 and 140′ which are disposed at a predetermined angle to each other or have curved surfaces corresponding to a curvature of the paper supplying unit 130, respectively. In this case, the plurality of array head cartridges 140 and 140′ may include head chips 145a and 145a′ aligned in one or more rows, and jet ink of different colors, respectively.

As illustrated in FIG. 3, the discharging unit 150 discharges the paper on which an image is formed in the array head cartridge 140 to the outside. The discharging unit 150 comprises a star wheel 151 which and restricts the surface of the paper by its rotation to be discharged to the outside, and a discharging roller 153 which rotates with the star wheel 151 across the paper. The description of the configuration of the star wheel 151 and the discharging roller 153 will be omitted as it is the same as the conventional configuration.

Meanwhile, the discharging unit 150 may further comprise a drying unit (not shown) for drying the paper on which ink is spread. The drying unit generates an air current like a fan, or heat like a heater to dry the ink.

An image forming process of the image forming apparatus 100 with the above-described configuration according to the present invention will be described by referring to FIG. 3.

First, if an output signal is applied from a host apparatus, the pick-up roller 113 rotates and transfers a paper of a paper feeding plate 111 to the transferring roller 120. The paper picked up by the pick-up roller 113 proceeds through the transferring roller 120, and its leading edge is first adsorbed onto the paper supplying drum 131 by an adsorptive force of the paper supplying drum 131.

At this time, the pressing roller 133 provided on one side of the paper supplying drum 131 presses the paper so that the paper can be maintained in the state adsorbed on the surface of the paper supplying drum 131.

The plurality of head chips 145a and 145b of the array head cartridge 140 spread ink on the paper transferred to the array head cartridge 140 in the state adsorbed on the surface of the paper supplying drum 131. At this time, the respective head chips 145a and 145b are provided to be separate with the same distance from the paper supplying drum 131, and ink jetting distances among the ink jetted from the respective color nozzles are provided to be reciprocally similar.

The paper on which an image is formed by the ink jetted from the array head cartridge 140 is removed of an adsorptive force of the paper supplying drum 131, is separated from the surface of the paper supplying drum 131 and is transferred to the discharging unit 150 to be discharged to the outside.

As described above, the array head cartridge according to the present invention is provided to have inclined lower surfaces and the similar jetting distances of the ink jetted from the respective color nozzles in comparison with the conventional array head cartridge having horizontal lower surface. Accordingly, the image quality can be enhanced without separately controlling the nozzles.

Also, in the case that plural rows of head chips are provided, the inclined surface of the array head cartridge is provided to have plural numbers to correspond with the curvature of the paper supplying drum.

Furthermore, according as the shape of the lower surface of the array head cartridge is improved, the diameter of the paper supplying drum need not be enlarged separately, thereby minimizing the size of the image forming apparatus.

As described above, the image forming apparatus according to the present invention is provided to have inclined lower surfaces of the array head cartridge so that the respective color ink jetting distances jetted from the head chips can be reciprocally similar.

Although a few exemplary embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus comprising:
a feeding part which feeds a printing paper;
an array head cartridge which has a plurality of head chips to ink onto the paper; and
a paper supplying drum which transfers the paper fed from the feeding part to the array head cartridge,
wherein the head chips are provided in plural rows on a lower surface of the array head cartridge, and the lower surface of the array head cartridge includes a plurality of inclined surfaces disposed to face the paper supplying drum and provided to have the same distances with respect to the paper supplying drum.

2. The image forming apparatus of claim 1, wherein each row of the head chips is disposed on a corresponding one of the inclined surfaces.

3. The image forming apparatus of claim 1, wherein the plural rows of the head chips are disposed on the respective inclined surfaces.

4. The image forming apparatus of claim 1, wherein the respective rows of head chips are alternately disposed with respect to a center of the rows.

5. The image forming apparatus of claim 1, wherein the inclined surfaces are inclined by a predetermined angle α satisfying the following formula with respect to the neighboring inclined surfaces,
α=2×[90°−{tan⁻¹(B/(R+A))}]
where B is a distance from a center of a transverse sectional surface of the array head cartridge to a center of the head chips, R is a radius of the paper supplying drum, and A is a distance from the center of the transverse sectional surface of the array head cartridge to the paper supplying drum.

6. An image forming apparatus comprising:
a feeding part which feeds a printing paper;
an array head cartridge which has a plurality of head chips to jet ink to the paper; and
a paper supplying drum which transfers the paper fed from the feeding part to the array head cartridge,
wherein the head chips are provided on a lower surface of the array head cartridge, and the lower surface of the array head cartridge includes a curved surface corresponding to a curvature of the paper supplying drum.

7. An array head cartridge comprising:
an ink storing part in which ink is stored; and
a plurality of head chips which are provided on a lower surface of the ink storing part and jet the ink of the ink storing part to a printing paper;
wherein the head chips are disposed on the lower surface of the ink storing part in plural rows, and the lower surface of the ink storing part having plural inclined surfaces which are corresponded to the plural rows and inclined toward a predetermined lower surface.

8. An array head cartridge comprising:
an ink storing part to store ink, and having a non-linear surface; and
a plurality of head chips formed on corresponding portions of the non-linear surface to eject the ink of the ink storing part.

9. The array head cartridge of claim 8, wherein the non-linear surface is not a flat surface.

10. The array head cartridge of claim 8, wherein the non-linear surface is a non-planar surface.

11. The array head cartridge of claim 8, wherein the non-linear surface is a curved surface, and the corresponding portions are different locations of the curved surface.

12. The array head cartridge of claim 8, wherein the corresponding portions of the non-linear surface include surfaces which are not parallel to each other.

13. The array head cartridge of claim 8, wherein the corresponding portions of the non-linear surface include surfaces which are inclined with respect to each other.

14. The array head cartridge of claim 8, wherein:
the non-linear surface comprises first and second surfaces which are not linear; and
the plurality of head chips comprise a first row of the head chips and a second row of head chips which are respectively disposed on the first and second surfaces.

15. The array head cartridge of claim 8, wherein the plurality of head chips are disposed in the non-linear surface in a zigzag pattern with respect to a center line of the plurality of the head chips.

16. The array head cartridge of claim 8, further comprising:
a main body containing the ink storing part and formed with the non-linear surface having a plurality of different portions as the corresponding portions,
wherein the plurality of the head chips are disposed on corresponding ones of the different portions.

17. The array head cartridge of claim 8, wherein:
the non-linear surface comprises first and second different linear surfaces disposed opposite with respect to a center line;
the plurality of head chips comprise first and second rows of head chips disposed on the respective first and second different linear surfaces; and
the center line and center lines of the first and second rows of head chips form a trigonal prism shape.

18. The array head cartridge of claim 8, wherein:
the non-linear surface comprises first and second different linear surfaces disposed opposite with respect to a surface center line;
the plurality of head chips comprise first and second rows of head chips disposed on the respective first and second different linear surfaces; and
a distance between the surface center line and one of head chip center lines of the first and second rows of head chips is longer than half a distance between the head chip center lines.

19. An image forming apparatus comprising:
a paper supplying unit having a paper supplying drum to feed a printing paper; and
an array head cartridge disposed to face the paper supplying drum, having an ink storing part to store ink, having a non-linear surface, and a plurality of head chips formed on corresponding portions of the non-linear surface to eject the ink of the ink storing part on the fed printing paper.

20. The image forming apparatus of claim 19, wherein:
the non-linear surface comprises first and second different surfaces disposed opposite with respect to a center line therebetween;
the plurality of head chips comprises first and second rows of head chips disposed on the respective first and second different linear surfaces; and
a distance between the center line and a surface of the paper supplying drum in a radial direction is longer than a distance between one of center lines of the first and second rows of head chips and the surface of the paper supplying drum in the radial direction.

21. The image forming apparatus of claim 19, wherein the plurality of head chips comprise chip surfaces disposed perpendicular to a radial direction of the paper supplying drum.

22. The image forming apparatus of claim 19, wherein the non-linear surface comprises first and second different surfaces disposed perpendicular to a radial direction of the paper supplying drum.

23. An image forming apparatus comprising:
a feeding part which feeds a recording medium;
a plurality of array head cartridges each having a plurality of head chips to ink onto the recording medium; and
a paper supplying drum which transfers the paper fed from the feeding part to the plurality of array head cartridges,
wherein each of the plurality of array head cartridges has a lower surface on which the head chips are provided in a plural rows, and the lower surfaces of the array head cartridges are disposed at a predetermined angle to each other while facing the paper supplying drum and provided to have the same distance from the paper supplying drum, respectively.

24. The image forming apparatus of claim 23, wherein the respective rows of head chips are alternately disposed with respect to a center of the rows.

25. The image forming apparatus of claim 23, wherein the lower surfaces are inclined by a predetermined angle α satisfying the following formula with respect to the neighboring lower surfaces,
α=2×[90°−{tan⁻¹(B/(R+A))}]
where B is a distance from a center of a transverse sectional surface of the array head cartridge to a center of the head chips, R is a radius of the paper supplying drum, and A is a distance from the center of the transverse sectional surface of the array head cartridge to the paper supplying drum.
